(19) United States
(12) Patent Application Publication
(10) Pub. No.: US 2021/0209536 A1
(43) Pub. Date: Jul. 8, 2021

(54) SYSTEM AND METHOD FOR MULTI-QUEUE MANAGEMENT

(71) Applicant: Callflow Software Ltd., Tel Aviv (IL)

(72) Inventors: Eran REUVENI, Tel Aviv (IL); Avraham Bar YEHUDA, Tel Aviv (IL)

(73) Assignee: Callflow Software Ltd., Tel Aviv (IL)

(21) Appl. No.: 16/733,905

(22) Filed: Jan. 3, 2020

(51) Int. Cl. G06Q 10/06

(52) U.S. Cl. CPC G06Q 10/06316

(57) ABSTRACT

A system and method for managing multiple queues may include receiving by a computer processor input from a first person indicating the first person is entering an in-person queue, and receiving by the computer processor input from a second person indicating the second person is entering a virtual queue. A next person to be serviced by an agent may be determined or chosen, the next person taken from the combination of the in-person queue and the virtual queue. That next person may be summoned or notified, for example that an agent is ready to interact with them.

### FIELD OF THE INVENTION

The present invention is directed to Queue Management System (QMS) systems and technology; for example technology allowing for the use of different types of queues.

### BACKGROUND

Queue Management Systems (QMS) are technology providing solutions for Customer Reception and Flow Management (CRFM) systems. Existing QMS technology may operate in-person, walk-in or “Take-a-Ticket” systems, which manage an in-person, live queue, where the people waiting in the queue are physically present at or nearby (e.g. waiting in the neighborhood) the same physical location as the agent or service provider providing the service for which the people in the queue are waiting. Such an in-person queue may be, e.g. a doctor's physical waiting room or a department of motor vehicles (DMV) location. Such an in-person system may for example issue a ticket bearing a number to a consumer of a service, or may use another method to issue a number or place in line, e.g. via a text message, and may summon the service consumer to receive the service by for example displaying or otherwise announcing the number, by text message, etc.

Existing queue management technology may operate virtual systems, which manage virtual queues, where the people waiting in the queue are typically not physically present or nearby. For example, the people waiting in a queue may be telephone callers or chat (e.g. instant message) users located physically remote from the physical location of the service provider or agent.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 shows a high-level block diagram of a queuing system according to embodiments of the invention;

FIG. 2 shows a logical block diagram of a computing device according to embodiments of the invention;

FIG. 3A is a flowchart for queue management according to embodiments of the invention;

FIG. 3B is a flowchart for queue management according to embodiments of the invention;

FIG. 3C is a flowchart for queue management according to embodiments of the invention; and

FIG. 3D is a flowchart for queue management according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY

A system and method for managing multiple queues may include receiving by a computer processor input from a first person indicating the first person is entering an in-person queue, and receiving by the computer processor input from a second person indicating the second person is entering a virtual queue. A next person to be serviced by an agent may be determined or chosen, the next person taken from the combination of the in-person queue and the virtual queue. That next person may be summoned or notified, for example that an agent is ready to interact with them.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time. Aspects of any one embodiment described herein may be combined with aspects of any other embodiment described herein.

Embodiments of the invention are directed to technology for combining, or the combined management, of computer-managed queues of different types. Some queues may not be actual lines, in that the users in the queue are not actually lined up, but still are collections of people waiting. Users in some queues (e.g. in-person queues) are typically physically present at the site (or physically nearby) for a service, meeting or other transaction, but need not be at the site the entire time they are in the queue. Users in other queues (e.g. virtual queues) may be at distant locations relative to an agent: for example an agent may be a doctor in city A, and a user in a virtual queue may be a patient at home in city B. Thus people in a virtual queue may be geographically distributed.

In one embodiment, a system may receive input from a first person indicating the first person is entering an in-person queue (e.g. a first type of queue), and may receive input from a second person indicating the second person is entering a virtual queue (e.g. a second type of queue). The people entering the queues may be “walk in” or FIFO customers. The system may determine or choose a next person to be serviced by or communicate with an agent, the next person taken or input from the combination of the in-person queue and the virtual queue. That next person may be contacted or summoned; if the person was from a virtual queue a communications session such as a phone or video call may take place.

Typically, when a user is served after being in an in-person queue, a face-to-face meeting with an agent occurs. The users may have a queue status presented publicly (e.g., on a monitor viewed by everyone in a waiting room). For example, a queue status (e.g., an ordered line of images, numbers, names, etc., each corresponding to a user) may be displayed. When a user desiring to enter an in-person queue or to meet with a service representative arrives at a site, the user may interact with a terminal or kiosk technology platform to announce or input information regarding the user's presence to a system managing queues, to “check in”, and/or to receive a number, ticket or token identifying the user's place in the queue and allowing the user to know when they are called. Other user-queue interfaces may be used: e.g. a user may be handed a paging device, or a user may enter a cellular telephone number to be called via text message. A user may also have a pre-scheduled appointment, which may obviate the need for check in, but a pre-scheduled appointment may require check in.

Typically, when a user is served after being in a virtual queue, an electronic meeting or communications session with an agent or service provider occurs, e.g. via a technology platform such as videoconference, telephone or other audio call, text or chat session, etc. When a user desires to enter a virtual queue or to meet with a service representative remotely, the user may for example click on (e.g. using a pointing device to a mouse) a link or button for a video chat or to enter a queue via a website, and may receive information (e.g. a communications link such as a video chat link; a number or other queue position or placement estimate, etc.). A user may also have a pre-scheduled appointment, which may obviate the need for check in, but a pre-scheduled appointment may require check in.

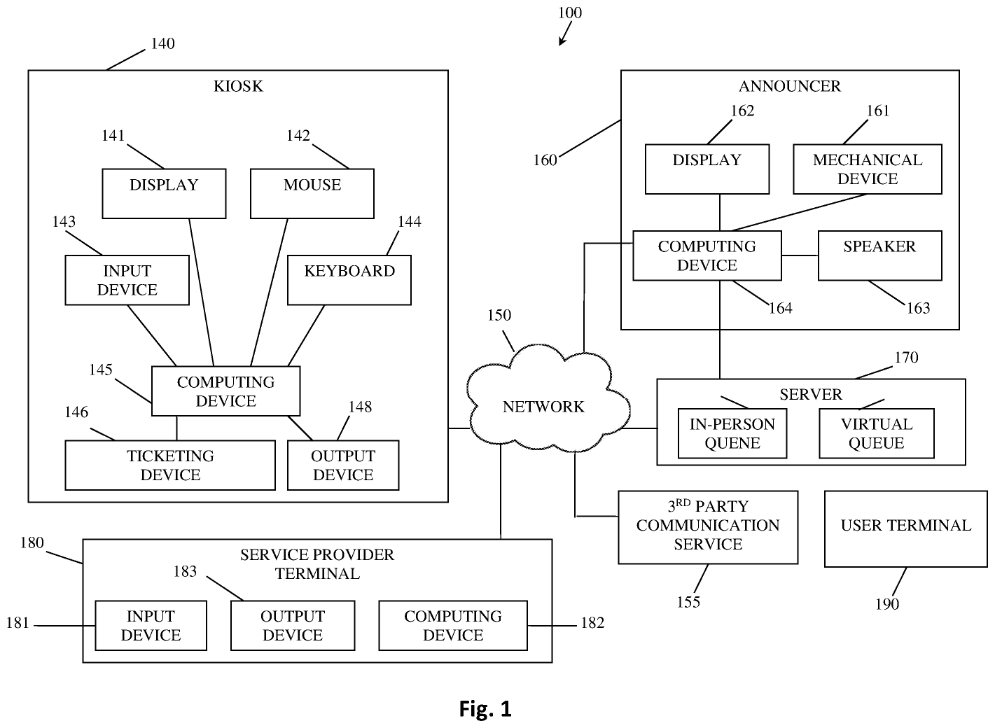

Reference is made to FIG. 1 showing a high-level block diagram of a queuing system 100 according to embodiments of the invention. Queuing system 100 may include an information kiosk 140, a service provider terminal 180, one or more remote user terminals 190, a server 170 and an announcer 160, all of which may be capable of communicating over network 150. System 100 may include multiple kiosks, terminals, servers, and announcers, and one physical device may support or contain multiple terminals, kiosks, and/or announcers. Network 150 may include multiple networks, e.g. a network internal to an organization, the internet, the telephone network, etc. In general, server 170 may coordinate the actions of components of system 100 and provide central storage of information, and in addition may communicate with other enterprise databases storing for example customer, product or service information.

A customer may wait in a real or virtual waiting area prior to being served by an agent. A virtual waiting area may be for example a Web page in which customers await their video call. Customers can exit and re-enter the waiting area.

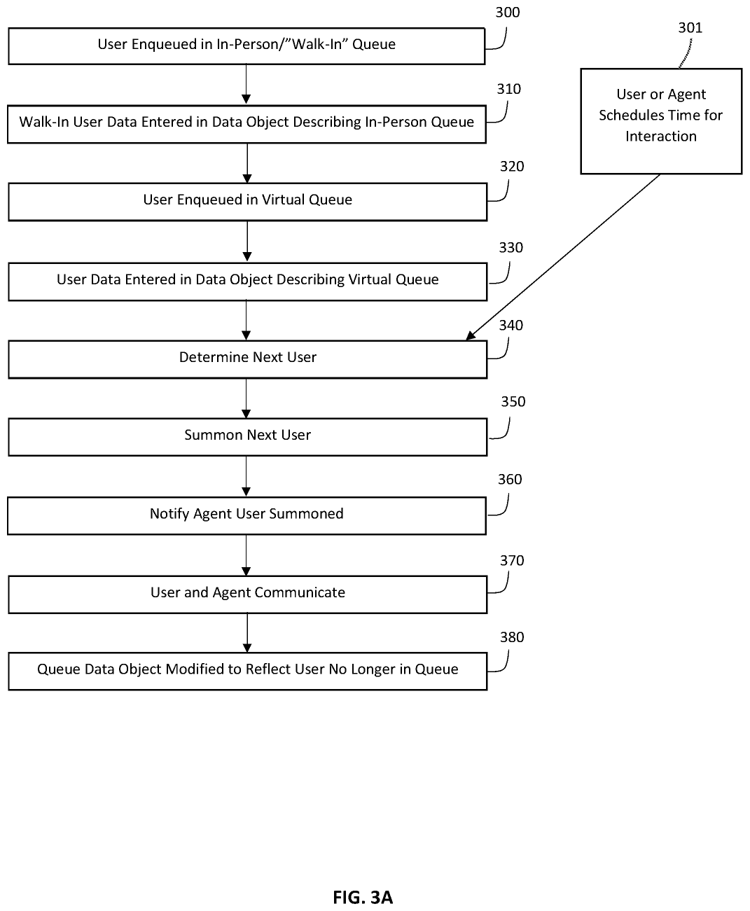

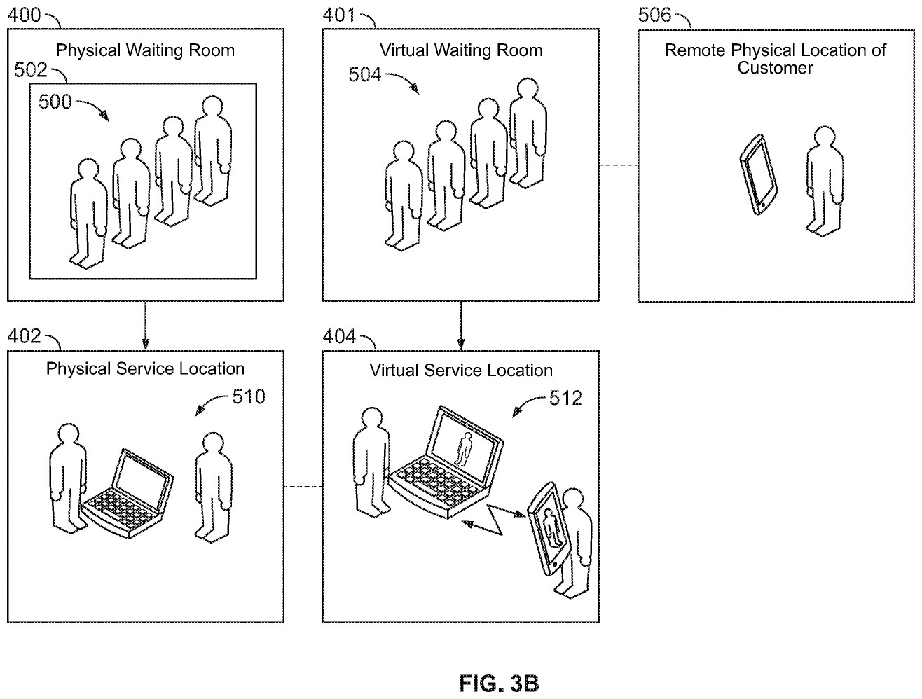

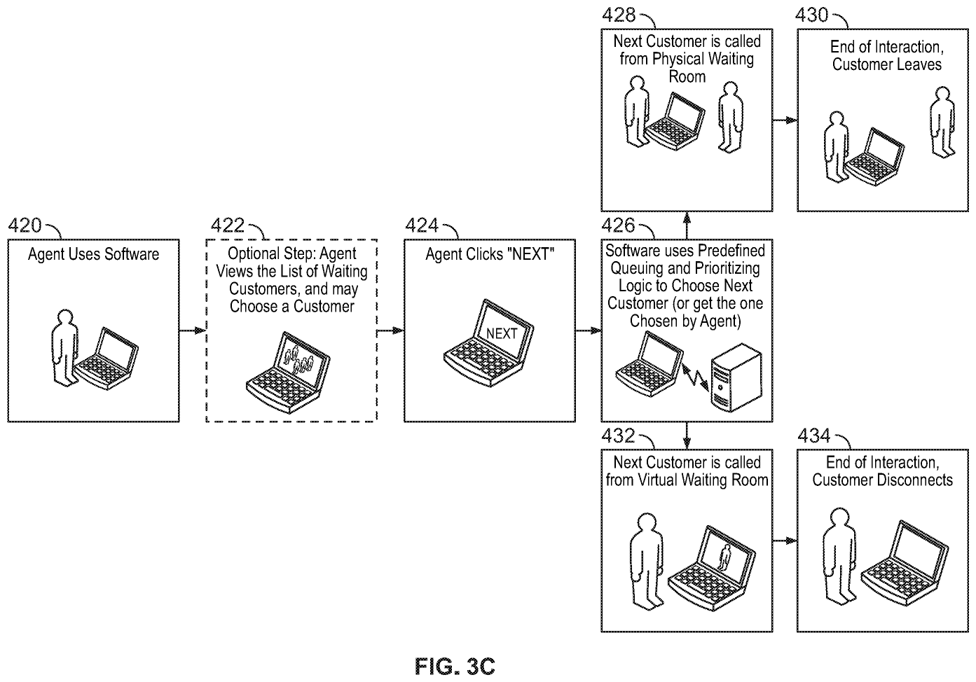

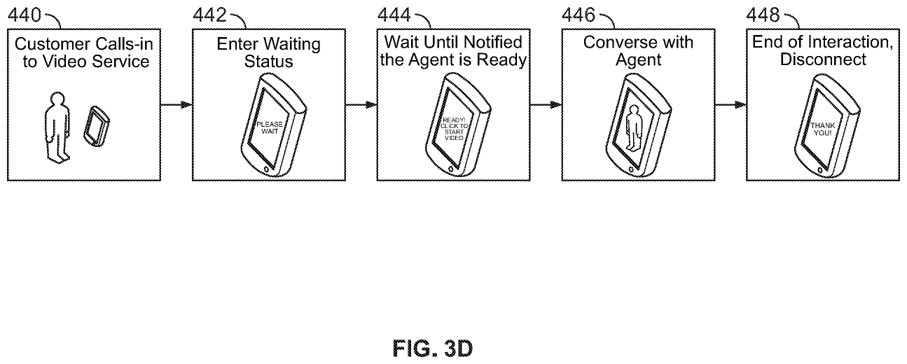

Server 170 may be a relatively small computer, e.g. a PC, and may be on-site, e.g. at the facility servicing the in-person queue, or may be remote, e.g. a larger computer or set of servers operating in the “cloud”. Server 170 may maintain or store data objects or databases representing real and virtual queues, e.g. real or in-person queue 172 may be a data object representing a real physical gathering of people, e.g. real or live queue 500 shown in FIG. 3B; and virtual queue 174 may be a data object representing virtual queue or waiting room 504 shown in FIG. 3B. Queues 172 and 174 are typically FIFO (first in first out) queues, and may have sub-queues which may be for scheduled, not “walk in” or first-come-first-served customers. Thus in some embodiments one or more queues representing users having pre-scheduled or calendared appointments may be used, and may be “sub-queues” part of queues 172 and 174, or may be separate queues.

Information in queues 172 and 174 or scheduled queues may include for example information that supports the interaction: e.g. contact information (e.g. telephone number, email address, which may be used to send a text or e-mail message the person to let them know they are being called, or thank them after the interaction concluded); name; and greeting (e.g. title etc.). Such a data structure may be for example a relational database, mark-up language like XML file, etc. Such data may be for example collected from sources such as (a) CRM (customer relationship management) system providing the basic customer information; (b) ad-hoc data entry providing data specific to the current service, such as selection of service request provided by the person on entering the queue; (c) any other IT (information technology) or other system information that can contribute relevant decision-support such as billing, sales or ERP (enterprise resource planning), and AI (artificial intelligent) systems that may provide analysis such as risk of churn or ad-hoc customer value; (d) queuing information itself, such as system status info like wait-times and agent workload; (e) the virtual channel platform systems, e.g. video platform, that may be used to collect data from the customer on entering the virtual queue; and (f) information from a calendar/scheduling system for appointments.

Third party communications service 155 may provide communications services, such as videoconference (e.g. the Vidyo, CISCO or Skype video communications services) or audio conversations, for example to connect specific agent and customer via terminals 180 and 190, coordinated or requested by server 170. For example, third party communications service 155 may provide or transmit software or a link (e.g. URL) to a specific agent and customer via terminals 180 and 190, which when selected, executed or clicked on, allow an agent and customer to communicate.

In some embodiments, terminal 190 requires a certain application, app or software in order to interact with server 170 to communicate with agents, and a customer may need to have registered with server 170 to communicate with agents. Registration may require, for example, the customer providing an e-mail address or other identifier such as a telephone number, and/or other registration or authentication information. Typically, a customer who is using a terminal 190 to communicate with an agent may be identified and/or contacted via certain identifiers, such as an e-mail address, telephone number, or other identifiers. Prior to engaging in a conversation with an agent, a terminal 190 may have to be configured or have software (e.g. video conference software) installed. Queue management functionality at server 170 may have to be configured to operate with third-party communications systems, e.g. operated by third party communications service 155.

Kiosk 140 may be used to interact with a user or consumer, such as a service consumer, for example in a facility that provides services. For example, customers or users entering a bank, or a mobile phone repair center or patients arriving at a medical facility may use a kiosk such as kiosk 140 to receive information, schedule appointments, check in, enter a queue for a service or conduct other operations related to services provided by the associated facility. In some embodiments, a user, when first entering an organization or facility, may provide user identification information (e.g., a name, a customer identification number) or a transaction code or other information. According to embodiments of the invention, a number of kiosks and/or a number of announcers may be placed in a facility.

A customer may interact with system 100 via devices other than kiosk 140, and the functions of kiosk 140 may be divided among other components. Kiosk 140 may include a display 141 that may present information to and take input from a service consumer, e.g., a monitor (e.g., a flat-screen or CRT) connected to computing devices such as a personal computer (PC). Information presented on display 141 may include any relevant information pertaining to goods or services provided by the relevant facility. For example, if kiosk 140 is placed in a medical facility then display 141 may provide information such as a list of medical services provided by the facility, a list of medical departments and their location, medical staff personnel currently available and/or any information that may typically be provided by an information providing entity. Kiosk 140 may be used for interacting with a user, e.g., display various services that may be selected, provide a user with feedback and the like.

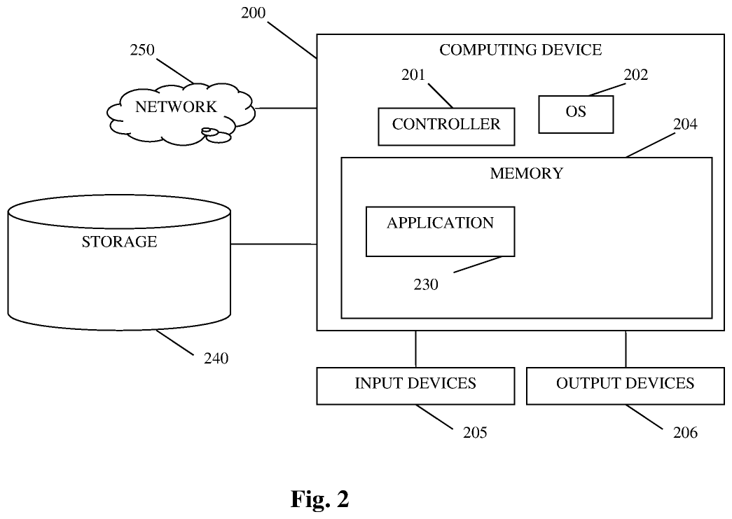

Kiosk 140 may further include input devices such as mouse 142, keyboard 144 or any suitable input device 143. For example, input device 143 or display 141 may be a touch screen and thus include an input device 143, or input device 143 may be any point and click device, an electronic touch pad, an electronic pen, a magnetic card reader or any other applicable input device. Kiosk 140 may include an output device 148, e.g. a speaker or any other suitable output device. Kiosk 140 may include a ticketing device 146. Ticketing device 146 may be a device capable of printing information on paper, plastic or other media and providing media bearing printed information to a user; ticketing device 146 may be a printer. Kiosk 140 may include a controller, processor or computing device 145. Computing device 145 may be a computing device such as computing device 200 described herein with reference to FIG. 2.

According to embodiments of the invention, queuing system 100 may include or be connected to one or more network(s) 150. Network 150 may include or may be part of a private Internet protocol (IP) network, the Internet, an integrated services digital network (ISDN), a set of frame relay connections, modems connected to a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding and/or any other suitable communication means.

Queuing system 100 may include an announcer 160. Announcer 160 may be used to announce, display, sound or otherwise convey information to an audience, typically those waiting in an in-person queue. For example, announcer 160 may announce the next patient to see a specific doctor or the next customer to receive a service. Announcer 160 may include a monitor or display 162 that may be any suitable one or more displays that may present any graphical information. Announcer 160 may be an electronic and/or electric display that may be used to display relevant information. For example, display 162 may be or may include a flat screen, plasma or cathode ray tube (CRT) display or any other suitable display system. Announcer 160 may include a speaker 163 that may be used to audibly announce any applicable information. More than one announcer may be used; e.g., one per room among several rooms, in some embodiments of the invention, announcer 160 may be connected, e.g., by wired or wireless technology, to a number of remote displays 162.

Announcer 160 may include any applicable mechanical device 161 that may be used to announce or inform users of events or other issues. For example, mechanical device 161 may be a mechanical display system such as seen and used in airports and train stations for displaying arrival and departure information. Announcer 160 may include a controller, processor or computing device 164. Computing device 164 may be a computing device such as computing device 200 described herein with reference to FIG. 2. Computing device 164 may control an operation of various components of announcer 160. For example, computing device 164 may control display 162, speaker 163 and/or mechanical device 161. Computing device 164 may coordinate an operation of components of announcer 160 and may further communicate, possibly by a network interface card (NIC), with network 150 and other computing devices connected to network 150.

Queuing system 100 may include a server 170. Server 170 may be or may include a computing device such as computing device 200 described herein with reference to FIG. 2. Server 170 may include or be operatively connected to a storage device such as shown in FIG. 2. Server 170 may execute various applications related to queue management, and may perform methods as described herein such as managing queues, communicating with agents or customers, providing notification, providing or organizing communication sessions (e.g. videoconferences, telephone or voice calls, chat sessions, etc.), etc. Server 170 may also be used by an administrator to manage queuing system 100, update information, e.g., services, staff related information and the like. Some functions described herein, such as providing communications sessions may be provided by computing systems external to server 170, e.g. telephone calls, etc. In such a case, in some embodiments, server 170 may provide information such as links or URLs to the relevant parties to organize, schedule, and allow for such communications.

Queuing system 100 may include a service provider terminal 180, used by a service provider, agent, sales representative, or other person providing a service for or otherwise interacting with a user or customer. For example, a doctor may use service provider terminal to engage in a communications session with an patient using, e.g. videoconference software operating at least in part on terminal 180 (such communications capabilities may be provided, e.g., by a third-party videoconference or other provider such as service 155 where terminal 180 interacts with a remote server operated by a third party; or by server 170, to provide such communications). Video or audio call capability, text chat capability, or other communications capabilities, may be provided by software installed e.g. on terminal 180 or server 170, and/or may be provided by an external provider using processors not shown, e.g. service 155, for example using the Vidyo video call service.

Terminal 180 may allow agents to initiate and receive both scheduled and unscheduled communications sessions, e.g. video calls, to and from customers, and to access and input information when interacting with in-person and remote customers. Agents may engage with customers using any channel application, e.g. text chat, audio calls, etc. A teller in a bank may use service provider terminal 180 when servicing a customer in order to receive information related to the customer and/or provide queuing system 100 with information related to the customer. A nurse or receptionist in a medical facility may use service provider terminal 180 to inform queuing system 100 that a specific patient has been treated and that no other treatments or services are required or pending. Such information may be used by queuing system 100, for example, in order to remove the patient from one or more lists or release other resources. Service provider terminal 180 may be a terminal for example executing a thin client as known in the art and may include components. Terminal 180 functionality may be provided via a combination of software executed on terminal 180 and server 170, or another computer platform. For example an agent or service provider may interact with a “Q-Flow Video Call Manager” software package, the functionality of which may be provided with local software executing on terminal 180 combined with or working with software executing on server 170.

Software executing on terminal 180 and/or server 170 may allow for transitioning seamlessly between various communications channels and also in-person visits (where the customer agent interact directly, without the user of terminal 180 but possibly with the use of information provided to the agent via terminal 180), audio or video telephone conversations, chat, or other types of communication.

Service provider terminal 180 may include input device(s) 181 that may include a point and click device such as a mouse, a keyboard, a touch screen or any other suitable input device, and which may include a camera used for videoconferencing, and a microphone used for communications sessions. Service provider terminal 180 may include output device(s) 183 that may include speakers for producing audio during communications sessions or a display such as display 141 or display 162. Service provider terminal 180 may include a controller, processor or computing device 182 that may be a computing device such as computing device 200 described herein with reference to FIG. 2. Computing device 182 may control any component of service provider terminal 180, e.g., output device 183 or input device 181, communicate with other components of queuing system 100 over network 150 and perform any other required operations related to the functionality of service provider terminal 180.

Queuing system 100 may include user terminal(s) 190, e.g. computers, telephones or mobile devices used by a user to communicate remotely with an agent or service provider. For example, a patient may hold a telephone call or videoconference with a doctor using a user terminal 190. In one embodiment a user terminal 190 may be a traditional telephone. User terminal 190 may include input device(s) (e.g. devices 205, FIG. 2) that may include a point and click device such as a mouse, a keyboard, a touch screen or any other suitable input device, and which may include a camera used for videoconferencing, and a microphone used for communications sessions. Service provider terminal 190 may include output device(s) (e.g. devices 206, FIG. 2) e.g. speakers or a display. Service provider terminal 190 may include or be a controller, processor or computing device such as computing device 200. The terms “consumer”, “consumer of a resource”, “consumer of a service”, “customer” and “user” may all refer to a person using or associated with embodiments of the invention as a queuing method and/or system.

Reference is made to FIG. 2 showing a computing device 200. According to embodiments of the invention, computing devices, servers or terminals 145, 155, 164, 182, 190 and 170 may be substantially similar to computing device 200 or may include any components included in computing device 200 and described herein. While computing device 200 and some its components are provided as an example any suitable processor or computing device may be used for computing devices 145, 164, 182, 190 and server 170. Computing device 200 may include a memory 204, central processing unit (CPU) or controller 201, storage device(s) 240, an operating system (OS) 202, input device(s) 205 and output device(s) 206. Storage device 240 may be any suitable storage device, e.g., a hard disk. Input devices 205 may include a mouse, a keyboard, microphone, camera or any suitable input devices and output devices 206 may include one or more displays, speakers, headphones or headsets, and/or any other suitable output devices. Input devices 205 and/or output devices 206 may include any applicable input/output (I/O) devices such as a network interface card (NIC), universal serial bus (USB) interface module or any other I/O devices.

According to embodiments of the invention, application 230 may be loaded into memory 204, for example, from storage 240 and may be executed by controller 201 under operating system 202. For example, application 230 may be any software tool, program or application related to queue management, e.g., ticketing, announcement or scheduling, or remote communications, such as a videoconference application, and may be loaded into memory 204 from storage device 240, any other storage system, or over network 150 and executed by controller 201. Controller 201 may be configured to carry out methods as described herein, by for example executing application 230. Application 230 may perform or help to perform methods described herein. Not all components or data objects shown in the example computing device 200 may be placed in, for example, a kiosk, announcer, server, or other device in embodiments of the present invention.

One or more users may physically enter a site (e.g. a medical facility) and “check in” to enter a queue, e.g. by interacting with and entering information into an information kiosk, which may be a computer processing device communicating (e.g. via a network) with a server, central on-site computer processor or other central computer, e.g. via a network. The server or other central computer may be on-site, e.g. at a medical facility, or remote, e.g. a server operating in the “cloud”. The server may receive input from the users via the kiosk, which indicates the users are entering the in-person queue, at the site. Users operating user terminals or computers, e.g. a PC at home communicating with the server via the Internet, may use such terminals to enter a virtual queue, and the server may receive the user input (e.g. via the user terminal) indicating this person is entering a virtual queue. The server may maintain or store the queues. An in-person queue data object may be a list, database or queue that represents the real-world gathering of people at a site. The server may maintain a virtual queue representing users who requested a service via remote terminals, located remotely from the site of the in-person queue (e.g. via their homes). The term in-person queue may refer both to the gathering of people at the site, having an ordering, the users waiting for service; and also a data object maintained by the server describing the in-person queue. The term virtual queue may refer both to the collection of people typically located remote from each other, the collection having an ordering, the users waiting for service; and also a data object maintained by the server describing the virtual queue.

The server or central on-site computer processor may analyze the queues, determine or choose which user or customer should be called next, direct (e.g. communicate with) the user or inform the user that the user is being served and possibly provide other information (e.g. where to go, which agent to go to, which software to use or which link on which to click), communicate with the relevant agent that a user or a certain user will interact with them, possibly coordinate the interaction (e.g. provide a URL or other links to a videoconference), and alter or update the queue data objects e.g. to indicate a person has left a queue and being serviced. For example the server may determine a next person to be serviced by or communicate with an agent, the next person taken or input from the combination of the in-person queue and the virtual queue, and summon or call the person, e.g. by sending the user a message via their user terminal, or operating an information kiosk, announcer system, or other messaging system to indicate which user is next. The server may display to the agent a message describing whether the next person is taken from the in-person queue or the virtual queue: e.g. the server may cause a service provider terminal to display a message indicating which user will see the agent next, possibly along with information regarding a communications session, e.g. a link to a videoconference. Each of the in-person queue, virtual queue and scheduled queue may include multiple queues. Different queues in each category may differ technically, for example one queue for video calls, another for chat discussions.

The queues described herein may have an ordering, typically a first-in-first-out ordering. For example in a real-world in-person queue, if person A enters the queue before person B, person A's order in the in-person queue and in the data representation of that queue will be before that of person B, and person A will become the first person in the queue before person B, and person A will be summoned to an agent before person B. However, exceptions to the ordering may occur: e.g. a person in a scheduled queue.

The example method of FIGS. 3A-3D may be carried out by equipment such as described in FIGS. 1 and 2, but may be carried out by other equipment. Further, aspects of the various embodiments shown in FIGS. 3A-3D may be combined with others of the embodiments shown in these figures. Embodiments shown in FIGS. 3A-3D may be used to organize the flow of customers to one or more agents. For example, the same agent (e.g. a doctor) may have such a method organize a flow of patients to the agent, some customers being remote and some customers meeting with the agent in person; in other embodiments such a method may organize a flow of customers to a pool or group of agents. If multiple agents are involved a customer may not be waiting for a specific agent, but for the next available agent in the group; alternately a specific customer may wait for a specific agent among a group of agents.

Reference is made to FIG. 3A showing an exemplary flowchart for queue management according to embodiments of the invention.

As shown by block 300, a customer may be enqueued in or enter an in-person or “walk-in” queue, e.g. in an un-scheduled (e.g. not previously planned or scheduled) manner E.g. a computer processor, e.g. a server or a central computer at a service site, may receive (e.g. from a kiosk or another computing device, or a mobile device such as tablet, smartphone or mobile telephone) input from a person typically physically present at the same facility as the agent providing service, indicating the person is entering an in-person queue.

In block 310, the computer processor, e.g. the server at the service site or a queue handling system, may enter or add data, or a record, representing or associated with the person in a data object describing the in-person queue. A number (e.g. an ordering number, a place in line, an estimated service time, a user ID, etc.) may be assigned to the person. A person may have a user ID which may be separate from an ordering number or place in line.

When used herein, in-person queue, virtual queue and scheduled queue may refer to the actual real-world queues (e.g. collections of users) and also the data objects representing these queues. A person entering or leaving a queue may mean both that the person joins or leaves the collection of people, and that information describing or associated with the person is added to or removed from the queue data object.

In block 301, in parallel to other processes, instead of entering a queue, a customer and/or agent may fix a specific time for the customer to speak to an agent, and that customer's speaking with an agent may be integrated with the process of agents speaking with other users who are in a queue. In such a case, at the time of the appointment, the agent (or in some cases an available agent if choosing among a pool of agents) may be connected with the customer via the appropriate communications method, where the time of connection may be the soonest possible time on or after the scheduled time, in the case the agent is communicating with another customer at the time of the appointment. For example, either the user or agent may use an interface to select a day, time, and method of communication for the appointment. In one embodiment, an email with a link to the video site where the appointment begins may be sent to the customer's email address; other methods of notification or confirmation may be used. Such a customer appointment may be recorded in a queue or database.

In block 320, a person may enter a virtual queue. The person may enter the queue. in an un-scheduled manner In one embodiment a user enters a virtual queue by clicking on a button or other clickable object presented by a GUI e.g. via an interface presented by some combination of programs executing on a remote server and a user terminal. For example, a person may use a designated “address” (e.g. the identifier or URL (universal resource locator) of the specific service that would take the call) such as may be provided on the business website, or may use a specialized program or app tied to a specific organization or service provider (e.g. operated by server 170), to request a video call. A computer processor, e.g. the server at the service site, may receive (e.g. from a user terminal such as a user's home computer or a user's smartphone) input from a person indicating the person is entering a virtual queue.

In block 330, the computer processor, e.g. the server at the service site, or a queue handling system, may enter or add data, or a record, representing or associated with the person having entered the virtual queue in a data object describing the virtual queue, e.g. data objects such as queues 172 or 174 maintained or stored by a server or computer. A number (e.g. an ordering number, a place in line, an estimated service time, a user ID, etc.) may be assigned to the person. A person may have a user ID which may be separate from an ordering number or place in line.

Input from users that they are entering queues may be received by computer devices (e.g. a kiosk at a service center, a home computer) separate from a computer processor maintaining the queue data structures and performing queue-related operations such as determining which customer to summon (e.g. a server 170). In other embodiments, an agent may enqueue a customer, e.g. via software on agent terminal 180: for example a customer may meet an agent, designated as greeter, who asks the person for required enqueueing information (e.g. service request, identification) and who operates a kiosk or another device to enqueue the customer.

In response to a customer entering a queue, queue or communications information may be sent to a customer, e.g. an email with a link to a video call internet site may be sent to the customer. After entering a virtual queue and before receiving service or entering a communications session with an agent, a person may be put “on hold” or enter a virtual waiting room. E.g. an “on hold” message may be displayed to the virtual queue user on a user terminal 190. Waiting information may be displayed on a user terminal 190, e.g. a user's place in line and/or expected wait time.

In some embodiments, after entering a queue or being registered with a non-queue appointment (e.g. a fixed time for a communications session), a user may receive a confirmation and/or a link to software to use for the communications session, e.g. a paper ticket with a number, a confirmation via text message to a customer's cellular telephone, an e-mail message including a link to video conference software or services, etc. Such confirmation may include a user's place in a queue or e.g. a “number” for a customer's place in a queue. In some embodiments, a user or customer may download the proprietary video-call software to e.g. customer terminal 190; such download information may be contained in a confirmation message, e.g. a link to use for software download. A person may receive a “place in queue” (where the person is in the queue) or wait time after entering a virtual or in-person queue.

While one in-person queue and one virtual queue are discussed, multiple such in-person queues and virtual queues, or sub-queues, may be maintained. Further one single data object—e.g. a database, may maintain or represent in-person and virtual queues, and scheduled or calendared queues or appointments.

In block 340 the computer processor or queue handling system may determine or choose a next person or user to be serviced by, communicate with or have an interaction with an agent. The next person may be taken from the combination of the in-person queue and the virtual queue, and also if used a queue or database representing scheduled or appointment-based customers. The processor may choose a record associated with the next person, the record being in one of the in-person queue and the virtual queue, or possibly a scheduled queue or database. An agent may signal s/he is ready to service the next customer by for example clicking or entering “next” into terminal 180 after finishing with the last customer and/or when ready for the next customer, and such information may be received by a queue handling system such as server 170. Logic to determine from which queue (e.g. in person vs. virtual) to take the next customer may be, for example, the person who waited the most, or the person with the most urgent case, based on earlier classification of the case; etc. If a scheduled queue or database is queue, a user with a scheduled appointment may take precedent over other queues when that person's scheduled time occurs.

In block 350, the computer processor may summon or notify the next person, user or customer, for example by providing an announcement via an announcing system at the site of the in-person queue, by transmitting a message to a computing device operated by a person taken from a virtual queue (e.g. via a message to a user's mobile telephone, or via a message to a user terminal). The summoning or notification may tell that next person that an agent is ready to interact with them. An in-person summoning, e.g. via a kiosk or announcing system, may use the public announcement of a number, symbol or avatar assigned to a person, or the person's name: information other than the name may be used to preserve anonymity. An in-person or virtual queue summoning may use a private announcement, e.g. to a person's cellular telephone.

A summoning of a person in a virtual queue from that queue may cause a screen of the user terminal 190 associated with that person to change to advise the person that their call or communications session will start now or soon, and the person can then provide input, e.g. click a button or on-screen icon, to start the session. A summoning of a person in a virtual queue from that queue may include sending a link, URL or other message to a user, for example via e-mail or text messages.

In one embodiment, summoning of a person in a virtual queue may require the person to click on or interact with a different link or button than that used to enter the queue, although it is typically but not necessarily the case that the same application or software, or API is used by the user to enter the queue and to notify the user when summoned, and possibly for the user to start a communications session. For example, when summoned a communications link, or other user selectable or clickable object, may appear in the application or API used to enter the queue, the link used to start the remote communications session Summoning a person from a virtual queue may include providing or transmitting to a user computer information required to enter a communications session, such as a communications link used to start the remote communications session. When summoned a virtual queue user may click on or select a button or clickable object that is provided by the application or URL that the person entered upon clicking the first link or button to enter the queue. In case that the user has left the first session after entering the queue and before being summoned, the user may be sent a message, and possibly link to enter the call.

Various combinations of user check-in and notifications, combining or separating scheduled and walk-in functions may be used. For example, one link, button or control may provide for scheduled and walk-in remote communications, where, upon selection or clicking, the user is asked whether they are checking in for their scheduled call, or prefer to check-in to for an unscheduled call and thus enter a virtual queue. An alternate implementation may not ask a scheduled user if she or he is scheduled or walk in, but rather upon clicking the link the user is immediately placed into the relevant queue or process. Another embodiment may provide different links or controls to scheduled and to unscheduled call users.

In one embodiment, after a user clicks or selects a link or button to enter a virtual queue, the user may be informed that there will be a wait. When the user is summoned, a second message may be sent to the user with a link to actually start the call.

In some embodiments, if a person has a fixed or scheduled appointment, at the time of the appointment, the person receives a notice, e.g. a reminder e-mail or other notice, and/or a link or other object (e.g. a URL to cause the execution of software, or a link which may be an input to already resident software) or other information allowing the person to join the communications session by clicking or following, or otherwise executing the link. If at the time of the appointment the agent or an agent is not ready, the person is put on hold or in a virtual waiting room until the time of the appointment. A queue for scheduled interactions or calls may include contact information for the scheduled customer. It may not be desirable for agent to attempt to make contact with a scheduled customer (e.g. a video call to the person at the time of the appointment) since that person may have forgotten about it or be in a situation where they cannot take a call. In some embodiments the person is required first to “check in” with or notify a system (e.g. server 170) of his or her presence and ability to enter a communications session, and/or to enter credential information, near the time of the scheduled interaction to provide an indication (e.g., via their mobile phone application) that they are available and ready to participate in the interaction as soon as the agent is available, before the person is contacted at or near the scheduled time. In some embodiments if a scheduled customer does not check in, she or he will not be contacted or provided with an ability to conduct a communication session at the scheduled time. Thus a user check-in notice may need to be received prior to transmitting to the user a link allowing the user to engage in a pre-scheduled appointment. An agent's terminal 180 may receive or generate a “virtual location”, address or other identifier for scheduled conversations for each scheduled customer, which may be used as an address to switch the agent's terminal to the specific person selected to interact with. At the time the agent is to interact with the person, the agent's communications (e.g. video) link may switch to an address corresponding to that person. When a virtual user or customer clicks the relevant link to check in or start the session, the session may not start immediately if the agent is still busy or with another customer, in which the case the customer will still be in a virtual waiting room until the agent indicates s/he is ready for the session. Thus in some embodiments, prior to the initiation of a remote communications session, the customer indicates “ready” prior to the agent.

In some embodiments, scheduled users who are available to call (e.g. have checked in at the time of an appointment) are summoned as soon as possible after that time; and that if no other person is in a FIFO/walk-in queue, may get called ahead of time. However, there may be a maximum wait time for the FIFO queues, so that if a person waits there longer than that time, and no other agent available to call her or him, they may get called prior to a person whose appointment has arrived or passed. Thus the choice or determination of the next person or user to be serviced may be based on the wait times of the people in the in-person queue and the virtual queue, and/or a maximum wait time allowed.

An in-person scheduled appointment user may check in using, e.g. a kiosk located at the facility providing the service, and the computer processor (e.g. server 170) may prioritize the in-person scheduled user over FIFO or walk-in users (virtual and in-person) if their appointment is after or some small time just before the current time.

In block 360, the computer processor may notify an agent (e.g. display a message to an agent) that a certain person has been summoned. For example, an agent terminal may advise the agent a customer is about to enter in person, or about to connect to the video call, so that they agent can prepare and accept the person or the call.

In some embodiments, if the customer is called from a virtual queue, a system operating the virtual queue (e.g. server 170) may contact a third party (e.g. separate from server 170) service, e.g. via an API (application programming interface), to establish a communications session and/or receive information such as a “meeting room number”, or a link or URL to execute communications software. A meeting room number or identifier may be used to distinguish among the different video or other communications links sent to individuals for specific communications sessions. All parties, e.g. the agent and the customer, may be provided a link (e.g. onscreen to the agent, and on-screen or via a text message or e-mail to the customer) and may be invited to call into the same virtual room. Once in the room after clicking or executing the link, the agent may start the call using, e.g. a video UI (user interface) and the customer may join the call via the video UI, thereby leaving the virtual waiting room.

Separate from meeting room numbers, a system may use different waiting room numbers or identifiers to distinguish among different virtual queues

In block 370, the customer or person and agent may meet and the agent may provide service. E.g. the person may enter a doctor's room, or engage in an audio call or videoconference with the doctor.

Before the user or customer uses software (e.g. video conference software) or enqueues, the customer may be required to enter credential information such as a user ID (e.g. an e-mail address, a cellular telephone number) and/or a password. Such customer credential information may need to be entered before a customer can download or access virtual communications software, or may need to be entered before such software allows a customer to enter a communications session or waiting area.

In block 380 the computer processor may alter the relevant queue data object (e.g. in-person queue or virtual queue) to reflect that the person is no longer in the queue, but rather is being serviced.

After the agent and customer have finished communicating, the agent may signal s/he is ready to service the next customer by for example clicking or entering “next”.

Other or different operations may be used.

Determining from which queue or database (e.g. in person vs. virtual vs. scheduled) to take the next customer may be based on, for example:
Information describing the person in the queue such as: customer segmentation data, such as customer level, club-membership, or other data that may indicate a person has higher priority in service; and “customer history” data, such as knowledge of past interactions, purchase history, risk-of-churn assessment, etc. that may also indicate the priority for serving a customer.
Information of an indication of the required service that would be provided by the person upon entering a queue (e.g. via kiosk in physical queue or via an application or web-form in virtual queue).
System information, such as current wait times, agent workload, opening hours, etc.
Business logic, e.g. a process or formula that takes data such as described above, and produces the queue and person selection as output.
Appointment-related information: for example, if a queue is for scheduled appointments, then people typically do not get called in order of arrival or in order of a-priori priority, but according to their scheduled appointment time (Assuming they arrived or checked in on time).

In some embodiments, fixed or scheduled appointments may be carried out by having an addition databases, queue(s) or subqueue(s), e.g. an additional queue for virtual or remote scheduled appointments, and an additional queue for in-person scheduled appointments. Customers with scheduled appointments may “show up” for their appointment (in person at a site for in-person, or by clicking a link, opening an app or otherwise providing input to a computer program for remote customers) to enter the scheduled queue or subqueue. Scheduled queues may differ from FIFO queues in that, as long as a customer enters the queue on time for their appointment, they skip people in queues with later appointments. When an agent calls the “next” customer, priority or advantage is given the appointment or pre-scheduled queues, to ensure that people get called close to the time for which they were scheduled. The next customer called is for FIFO (first come first served) queues unless another customer in a scheduled queue has priority, priority being given for example if the person's appointment is after or some small amount of time before the current time. In such embodiments, an appointment for a certain may cause the agent to interact with the customer as soon as the, or an/agent is available after the time of the appointment, or after the customer joins the system or enqueues, if the customer is slightly early, before an appointment. An embodiment may have a threshold for allowed earliness or lateness.

FIG. 3B is a flowchart for queue management according to embodiments of the invention. In operation 400, customers may gather in a physical location (e.g. hospital) in an in-person, live queue 500 (which need not be an actual line, and which may be spread across a number of locations, e.g. a number of rooms at a hospital); and in or via a virtual queue. Live queue 500 may be a physical gathering of people in a physical location, e.g. a waiting room 502, and may be represented by a data object, in-person queue data object 172. In operation 401, customers enqueue in virtual queue or waiting room 504. Virtual queue or waiting room 504 may not exist physically, but may be in some sense physically represented by a number of people at separated physical locations 506 (e.g. a person's home, place of business, etc.) and may be represented by a virtual queue data object 174. In operation 402, a customer from live queue 500 may be served by an agent at a physical service location 510, and in operation 404, a customer from virtual queue 504 may be served by an agent at a service location 512. If one agent or one set of agents is used (e.g. same agent(s) looking to serve both types of customers, from either physical or virtual waiting rooms), operations 402 and 404 may take at different times, and service locations 510 and 512 may be the same location—the location of the agent(s). A number of both physical and virtual waiting queues may be used.

FIG. 3C is a flowchart for queue management according to embodiments of the invention. In operation 420, an agent may use software executed by an agent terminal 180 or server 170 to for example view the details (operation 422) of the queues 172 and 174, and possibly of the people waiting in queues 500 and 504, to select who to call next, or may just click “NEXT” (operation 424) and let a system (e.g. server 170) decide (operation 426) based on pre-defined business logic. If a customer is called from a physical queue, that customer may approach the agent to meet in person, in operation 428, and after the interaction the customer may leave, operation 430, and the agent may be freed for another interaction. If a customer is called from a virtual queue, operation 432, then as soon as the customer accepts to join the call or communications session, the video call window would start or pop up on the agent's screen, to engage in the call, and after the interaction the customer may exit the session, operation 434, and the agent may be freed for another interaction.

FIG. 3D is a flowchart for queue management according to embodiments of the invention, depicting an example experience in the eyes of a customer waiting in a virtual line or queue. In operation 440, a customer calls or logs into a service, e.g. a video service, for example per a spontaneous unscheduled decision of the customer's, by clicking on an “invitation” or “appointment reminder” received from a service, or by any other method. A customer may use a customer terminal 190 which may be for example a cellular telephone, tablet, desktop, etc. In operation 442, the customer may enter the virtual waiting line. In one embodiment, a screen or display may advise the customer to wait until the agent is ready to take the call. In operation 444, when the system (e.g. server 170) chooses to call the customer, a notification may be provided or displayed. For example, a customer may be advised to click on a screen display icon or button when ready to accept the call. In operation 446, the customer and agent may converse or communicate, e.g. via video or via another communication channel. In operation 448, the parties may disconnect.

In some embodiments, a user may have a pre-existing appointment before, or instead of, approaching a kiosk or en-queueing into a virtual queue. The site or system may support multiple queues within each of a virtual and in-person queue, and multiple services (e.g., product sales, product repair, etc.). Alternately, only one queue may be supported. If multiple queues are supported, a display may display information, symbols or objects representing multiple queues.

A user entering a queue may register or otherwise provide and receive identifying details to/from a service provider and may accordingly be identified, for example, by system 100. For example, during a registration a user may be provided with an identification number, code or parameter, for example, stored on a magnetic card. A customer may, upon arrival to a location where a service is provided, interact with a reception entity such as kiosk 140, or may interact with system 100 remotely via a user terminal. The customer may enter an identification code or parameter previously provided. A dialog box or other graphical object displayed on a kiosk or user's terminal may provide the user with information such as for example, the user's name (as a form of verification), details related to the service to be provided, schedules, details such as name of personnel or service provider to meet and a code or parameter such as a ticket, ordering or line number A ticket, receipt or other token or indicator may be generated or presented to the user. Information generated and/or presented to the user may include any relevant or applicable queuing information. The ticket may include information, such as a customer number, and an advertisement (possibly tailored to the user or the service associated with the user). If customer anonymity is desired (which may be achieved by associating an object rather than a name with a customer), the ticket may include only information that cannot be easily connected to the customer's identity, such as an image chosen by the customer. Other information may be printed on a ticket by a ticketing device or presented to a user via a user terminal. For example, the number of service consumers waiting to be served, the average or expected wait time and/or any other information that may available to, or computed by a queuing system as known in the art may be provided.

As users are served by service providers (who may operate, for example, service provider terminals 180), users advance in the relevant queue(s). Multiple queues may be used within an in-person queue and a virtual queue (e.g., one queue per agent). One queue may feed into multiple service providers (e.g., multiple doctors each servicing the next person in one queue). For example, the first user in a queue may have an associated object or number shown in a queue on a monitor, and this first, “being served now” object or number, may be displayed differently from other objects in the queue to show that the associated user is being served first. For example, the object or number may be enlarged, bordered, framed, or otherwise emphasized, but this need not be the case. As users complete being served, they are taken off the relevant queue, their object or number is removed, for example, from display 162, and objects or numbers in the queue displayed on the monitor may advance.

A queue status, state or any other relevant information related to consumers of a service waiting to be served may be displayed or presented, for example on display 162 or via another device or devices. The status may be displayed using some identification of a user. The queue status may include, for example, an ordered list or line showing all or some of the people waiting in a queue, the first person in the queue, the person currently being served, an estimated wait time, or other information. People or users may be represented in a queue status by, e.g., numbers, names, or images or symbols associated with the people.

To summon a user, a predefined text string or a user selected text string may be displayed, e.g. via an announcer or user terminal, or a user terminal 190 may receive a message such as the status of a display changing, or an e-mail message or text message.

According to embodiments of the invention, during service or upon concluding providing a service to a customer, an agent or service provider may use service provider terminal 180 to perform various management or other tasks. For example, service provider terminal 180 may provide a bank teller with information related to the customer currently being served by the teller. For example, such information may be displayed on output device 183 that may be a display. An agent or service provider may use service provider terminal 180 to interact with queuing system 100, for example to remove the customer from the relevant queue, signal that the agent is done servicing a customer and/or is ready for the next customer, etc.

In some embodiments of the invention, various components or features of system 100 described herein may be included in a single or plurality of substantially identical or similar devices. The distribution of functionalities as described with reference to system 100 may be implementation dependent and embodiments of the invention are not limited in this respect.

Embodiments may be implemented in software for execution by a processor. For example, embodiments may be implemented in code and may be stored on a storage medium having stored thereon instructions (e.g., computer-readable instructions) which, when executed by a processor or controller, cause the processor or controller to carry out a method according to an embodiment of the present invention. The storage medium may include, but is not limited to, any type of disk including floppy disks, optical disks, compact disk read-only memories (CD-ROMs), semiconductor devices such as read-only memories (ROMs), random access memories (RAMs), such as a dynamic RAM (DRAM), erasable programmable read-only memories (EPROMs), flash memories, or any type of media suitable for storing electronic instructions.

Embodiments of the invention may improve existing queue management technology. Allowing different types of queues to be managed by one system may allow for a unified business logic, making sure that all customers are prioritized according to the logic that the business finds suitable for its needs, and may prevent the need for a human to make a decision whether to call a person from one queue or another. A unified UI provided to agents may allow management of all types of queues, improving efficiency, and eliminating the need to switch between systems. Embodiments may allow a business to provide a better service and waiting experience to its customers on both in-person and virtual queues. Embodiments may improve customer or patient experience and engagement, and may allow for easy integration of queue functionality with customer-facing interaction channel or workflow. Customers may easily engage with agents using a variety of channels and a variety of scheduling mechanisms (e.g. pre-planned and unscheduled) through one single application or platform.

Embodiments of the invention may manipulate data representations of real-world entities such as users in a queue or line, and create or process this information, possibly using other information, to create and display new and useful information or data derived from this information, such as for example the place or status of a user in a line.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method comprising:
receiving by a computer processor input from a first person operating a first computing device located at a site indicating the first person is entering an in-person queue at the site;
receiving by the computer processor input from a second computing device operated by a second person indicating the second person is entering a virtual queue;
wherein the second computing device is located remotely from the site of the in-person queue;
determining, at the computer processor, a next person to be serviced by an agent, the next person taken from the combination of the in-person queue and the virtual queue; and
summoning, by the computer processor, the next person.

2. The method of claim 1, comprising summoning a next person taken from the virtual queue by transmitting a message to the second computing device operated by the person taken from the virtual queue.

3. The method of claim 1, wherein the input from a first person indicating the first person is entering an in-person queue is received at a computer terminal separate from the computer processor.

4. The method of claim 1, wherein the in-person queue comprises multiple queues.

5. The method of claim 1, comprising maintaining, by the computer processor, the in-person queue and the virtual queue.

6. The method of claim 1, comprising maintaining a queue representing users with pre-scheduled appointments.

7. The method of claim 1, comprising receiving a person's check-in notice prior to transmitting to the user a link allowing the person to engage in a pre-scheduled appointment.

8. The method of claim 1, comprising determining the next person to be serviced based on the wait times of the people in the in-person queue and the virtual queue or a maximum wait time allowed.

9. The method of claim 1, wherein summoning a person from a virtual queue comprises transmitting to a user computer a communications link used to start a remote communications session.

10. A system comprising:
a memory, and
a processor configured to:
receive by a computer processor input from a first person operating a first computing device located at a site indicating the first person is entering an in-person queue at the site;
receive by the computer processor input from a second computing device operated by a second person indicating the second person is entering a virtual queue;
wherein the second computing device is located remotely from the site of the in-person queue;
determine, at the computer processor, a next person to be serviced by an agent, the next person taken from the combination of the in-person queue and the virtual queue; and
summon, by the computer processor, the next person.

11. The system of claim 10, wherein the processor is configured to summon a next person taken from the virtual queue by transmitting a message to the second computing device operated by the person taken from the virtual queue.

12. The system of claim 10, wherein the input from a first person indicating the first person is entering an in-person queue is received at a computer terminal separate from the processor.

13. The system of claim 10, wherein the in-person queue comprises multiple queues.

14. The system of claim 10, wherein the processor is configured to maintain the in-person queue and the virtual queue.

15. The system of claim 10, wherein the processor is configured to maintain a queue representing users with pre-scheduled appointments.

16. A method comprising:
adding to an in-person queue data object a record associated with a first person operating a first computing device located at a site;
adding to a virtual queue data object a record associated with a second person operating a second computing device;
wherein the second computing device is located remotely from the site of the in-person queue;
choosing, by a computer processor, a record associated with the next person being in one of the in-person queue and the virtual queue; and
notifying, by the computer processor, the next person.

17. The method of claim 16, comprising notifying a next person taken from the virtual queue by transmitting a message to the second computing device operated by the person taken from the virtual queue.

18. The method of claim 16, wherein input from a first person indicating the first person is entering an in-person queue is received at a computer terminal separate from the computer processor.

19. The method of claim 16, wherein the in-person queue comprises multiple queues.

20. The method of claim 16, comprising maintaining a queue representing users with pre-scheduled appointments.
